(19) United States
(12) Patent Application Publication
(10) Pub. No.: US 2007/0071584 A1
(43) Pub. Date: Mar. 29, 2007

(54) Automated systems, apparatus, and methods for traffic channelizer removal, placement, storage, and transport

(76) Inventors: Gary K. Beckstead, Woodland, UT (US); Troy W. Beckstead, Salt Lake City, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/526,553

(22) Filed: Sep. 25, 2006

Related U.S. Application Data
(60) Provisional application No. 60/719,767, filed on Sep. 23, 2005.

(51) Int. Cl. B60P 1/04

(52) U.S. Cl. 414/467

(57) ABSTRACT

Disclosed are embodiments of systems, methods, and apparatus for the automated placement and removal of traffic channelizers, such as traffic barrels. Some embodiments include a traffic channelizer handler unit for removing a traffic channelizer from a roadway and for subsequent placement of the traffic channelizer on the roadway and a storage unit for receiving the traffic channelizer. The traffic channelizer handler unit may be configured to place the traffic channelizer in the storage unit during a load process and retrieve the traffic channelizer from the storage unit during an unload process.

### RELATED APPLICATIONS

This application claims the benefit under 35 U.S.C. § 119(e) of U.S. Provisional Patent Application No. 60/719,767, filed Sep. 23, 2005, and titled “AUTOMATED APPARATUS FOR TRAFFIC CHANNELIZER REMOVAL, PLACEMENT, STORAGE, AND TRANSPORT,” which is incorporated herein by specific reference.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a perspective view of one embodiment of an automated traffic channelizer placement and removal apparatus.

FIG. 2 is a perspective view of one embodiment of a storage unit shown from the perspective of the front of the storage unit.

FIG. 3 is an overhead plan view of one embodiment of a traffic channelizer handler unit.

FIG. 4 is a perspective view of one embodiment of a pick/place unit.

FIG. 5 is a rear elevation view of one embodiment of a traffic channelizer handler unit.

FIG. 6 is a perspective view of one embodiment of a base locator plate.

FIG. 7 is a perspective view of one embodiment of a base transfer unit.

FIG. 8 is a perspective view of one embodiment of a base manipulator unit.

FIG. 9 is a bottom perspective view of the base manipulator unit of FIG. 8.

FIG. 10 is a perspective view of one embodiment of a drum transfer unit.

FIG. 11A is an elevation view of one embodiment of a storage unit showing a stop mechanism positioned at the end of a storage canister, the stop mechanism shown in a closed configuration.

FIG. 11B is an elevation view like that of FIG. 11A, but with the stop mechanism shown in an open configuration.

FIG. 12 is a perspective view of one embodiment of a drum actuator unit.

FIG. 13 is a perspective view of one embodiment of a crawler unit.

FIG. 14 is an alternative perspective view of the crawler unit of FIG. 13.

### DETAILED DESCRIPTION OF PREFERRED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments.

Disclosed are embodiments of systems, methods, and apparatus for the automatic removal and/or placement of traffic channelizing devices (traffic channelizers) currently used in road or highway construction industry for traffic control or management. Such channelizing devices may include, for example, drums or barrels, cones, or tubular markers (referred to collectively as traffic channelizers in this document).

Embodiments of the invention may be used to provide a method of removal, pickup, and/or placement of traffic channelizers, and may also be used to provide a method for storage and transport of such channelizers. Some embodiments may be configured to operate in conjunction with traffic barrels that include a drum portion and a base portion, wherein the drum portion is separable from the base portion. In such embodiments, the automated apparatus may be configured to separate the drum portion of a traffic barrel from its base portion after removing the traffic barrel from a roadway. Likewise, such embodiments may be configured to reattach traffic barrel drum portions to traffic barrel base portions prior to re-placement of the traffic barrels on a roadway. Various embodiments of the invention may include articulating actuators, transfer or conveying devices, storage canisters, trailer assemblies, power generation, and fluid power devices designed and assembled to perform the desired methods of operation.

One embodiment of the invention is a trailer-mounted assembly that is pulled behind a vehicle. Other embodiments of the invention may be self-contained and drivable with each of the necessary components to provide for automated placement and removal of traffic channelizers. Vehicles suitable for use in connection with embodiments of the invention may include any vehicle of sufficient towing capacity to pull and safely maneuver the apparatus. Such vehicles are typically driven and guided by a driver/operator. The operator guides the vehicle along the desired path for the removal or placement of traffic drums or other traffic channelizers. Traffic channelizers in position may be picked up automatically from the roadway by a pick/place unit, and may then be moved along various automated components to a storage unit including one or more storage canisters. Traffic channelizers to be unloaded or placed on a roadway may be removed automatically from the storage canisters and moved along automated components to the pick/place unit, which places the traffic barrels or other traffic channelizers on the roadway. In one embodiment, traffic channelizers may be removed and/or placed on the roadway at speeds up to, but not necessarily limited to, thirty miles per hour.

Certain embodiments of the apparatus consist of two units: a traffic channelizer storage unit and a traffic channelizer handler unit. In some embodiments, the handler unit may be releasably attached to the storage unit so that a single handler unit can be used in connection with a plurality of storage units, thereby increasing the utility of the system and decreasing system costs. When both units are connected, the apparatus is ready for operation.

In some automated embodiments, the system may be computer controlled. The computer may be used to monitor and control all movements within the apparatus. The operator or driver may have monitoring capability and supervisory control over the operation of the apparatus.

The handler unit may provide for the placement and retrieval of the traffic channelizers to or from the roadway as well as to or from the storage unit. The handler unit may have an articulating pick/place actuator with a gripper or manipulator that places or removes the traffic channelizer to or from the roadway. The speed with which the pick/place actuator moves may correspond or be linked with the speed of the vehicle. Actuator movement may be controlled to remove or place the traffic channelizer without tipping the traffic drum during pick or place operations. The pick/place unit may place or retrieve the channelizers/drums from a transfer device. The transfer device may be used to move the drum to or from the storage actuators.

In certain embodiments, there may be two storage actuators. One actuator (the drum actuator) may operate to remove or connect the top portion of a drum and move this portion to or from its associated storage canister. The other actuator (the base actuator) may be used to grip the drum base portion and move it to or from its associated storage canister. When the drum actuator receives a drum from the transfer device, the drum actuator gripper may clamp the drum, remove the drum from its base, and then move the drum to the drum storage canister. Likewise, the base actuator gripping the base may be used to move the base to the base storage canister. During a drum placement operation, when a remove-drum command is issued, both the base and drum actuators may be directed to their associated storage canisters. The actuators may then each remove its associated base or drum. The base may be moved to the transfer load position, followed by the drum. The drum actuator may also be used to connect the drum to the drum base. The drum/base unit is then ready to be moved to the transfer device.

The transfer device may be used to transport and accumulate drums between the pick/place unit and the drum/base actuators. The computer controller may be used to monitor the count of drums and bases in each canister located on the storage unit. When a canister is full, canisters may be shifted as required to place canisters in the proper loading or unloading position. The computer controller may be used to coordinate both actuators and storage canisters for the proper location, as well as loading and unloading interface with the drum and base actuators.

The drum and base storage canisters allow for moving, holding, and releasing of drums or bases. Each canister may provide for a method of moving drums or bases during loading and removal operations. During canister unloading, the drums may be moved to a stop at the opposite end of the canister. Each canister may operate independently for loading or removal operations. The canister stops may be operated by the computer controller (or may be operated mechanically) to coordinate the removal of the base or drum with its associated base or drum actuator. When an actuator is in a receiving position, the stop may be removed/opened and the drums or bases moved into a holding mechanism of an actuator. The actuators may then move to a suitable position to load the transfer device. In this position, the drum may be connected to the base and thereby readied for roadway placement.

The combined drum/base unit may then be moved to the transfer device where it is moved into position for receipt by the pick/place unit. The pick/place unit may receive the drum/base unit and move the unit into position to locate the drum unit on the roadway. When the pick/place unit receives the place command from the computer controller, the drum unit may be placed on the roadway. Storage canisters and the drum handler components may be sized to facilitate use with most standard traffic barrels.

An on-board power generation/fluid power device, such as a hydraulic power unit and accompanying components, may provide the source of power for movement of the various automated components on the apparatus.

The speed of operation of the apparatus may allow traffic drums and other traffic channelizers to be placed and/or removed from roadways faster and more efficiently than the current manual, labor-intensive methods. The storage capability may also provide for efficient traffic channelizer management and inventory control. The storage system may further provide protection for the traffic channelizer investment. Traffic channelizer placement and retrieval can be accomplished without workers being directly involvement in hazardous traffic flow. The speed of the operation may allow drums and other channelizers to be placed and/or removed while minimizing traffic flow disruptions. The ease of operation may justify the removal of the traffic channelizers from the roadway when not in use, rather than moving them off to the side of the roadways, thereby removing traffic hazards. This may also protect the traffic channelizer investment from unnecessary loss or damage.

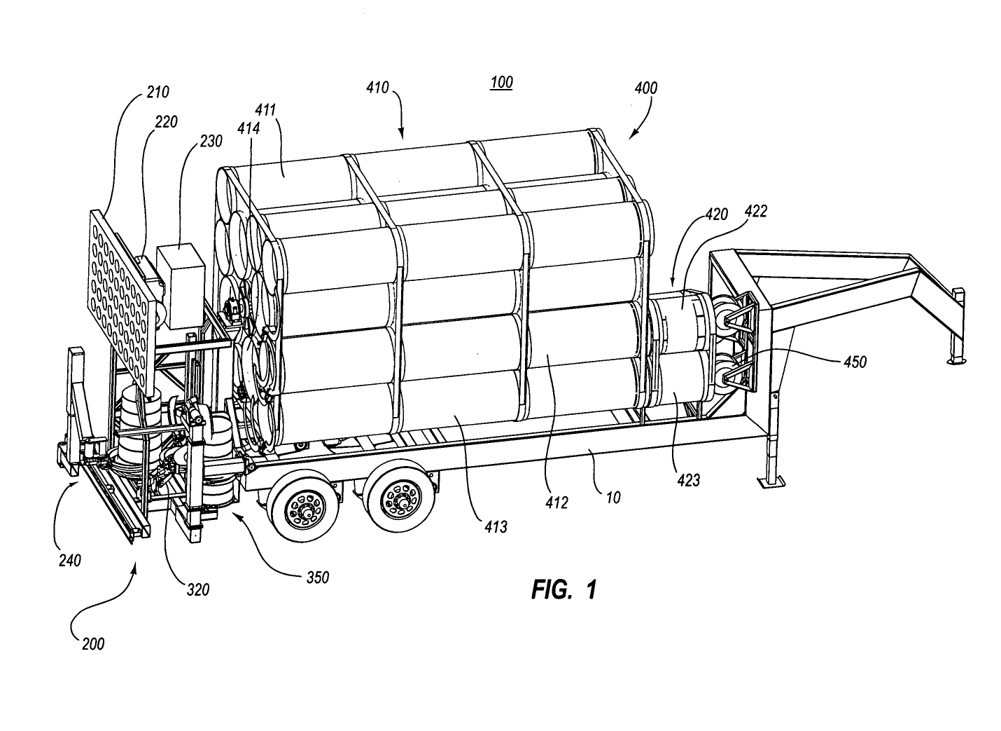

One particular embodiment will now be described in greater detail with reference to the accompanying drawings. FIG. 1 shows an automated traffic channelizer placement and removal apparatus 100. Apparatus 100 includes a traffic channelizer handler unit 200 and a storage unit 400. Traffic channelizer handler unit 200 is detachably connected to storage unit 400, and is also detachably connected to a trailer 10. Tube sockets (not shown) may be provided on the storage unit 400 and corresponding connector tubes (not shown) may be provided on the handler unit 200. The connector tubes may be configured to slide into the sockets, thereby attaching and supporting the handler unit 200 to the storage unit 400. Locking Pins may be placed into corresponding locking holes, which may be aligned through both of the tube sockets in the storage unit 400, and the connector tubes of the handler unit 200, by the operator to lock/secure the handler unit 200 in place. Traffic channelizer handler unit 200 may thereby be removed from trailer 10 and storage unit 400 and subsequently connected with another trailer/storage unit. Accordingly, a single traffic channelizer handler unit may be used in connection with a fleet of trailers and/or storage units.

Traffic channelizer handler unit 200 comprises an optional warning sign 210, an engine 220, a hydraulic reservoir 230, a pick/place unit 240, a drum transfer unit 320, and a drum actuator unit 350. Each of these components will be described in greater detail below, along with additional traffic channelizer handler unit 200 components which aren't easily perceived in FIG. 1.

Storage unit 400 comprises a carousel assembly 410 including a plurality of storage canisters 411, each of which is configured to receive a plurality of traffic channelizers in a nested configuration. In the depicted embodiment, the storage canisters 411 are configured in four groups of three (triplets). Apparatus 100 is configured to operate in conjunction with traffic channelizers comprising traffic barrels, each of which includes a drum portion and a separable base portion. Two of the three storage canisters in a given triplet are configured to receive the drum portions of a plurality of separable storage barrels, and the third storage canister in the triplet is configured to receive the base portions of the storage barrels.

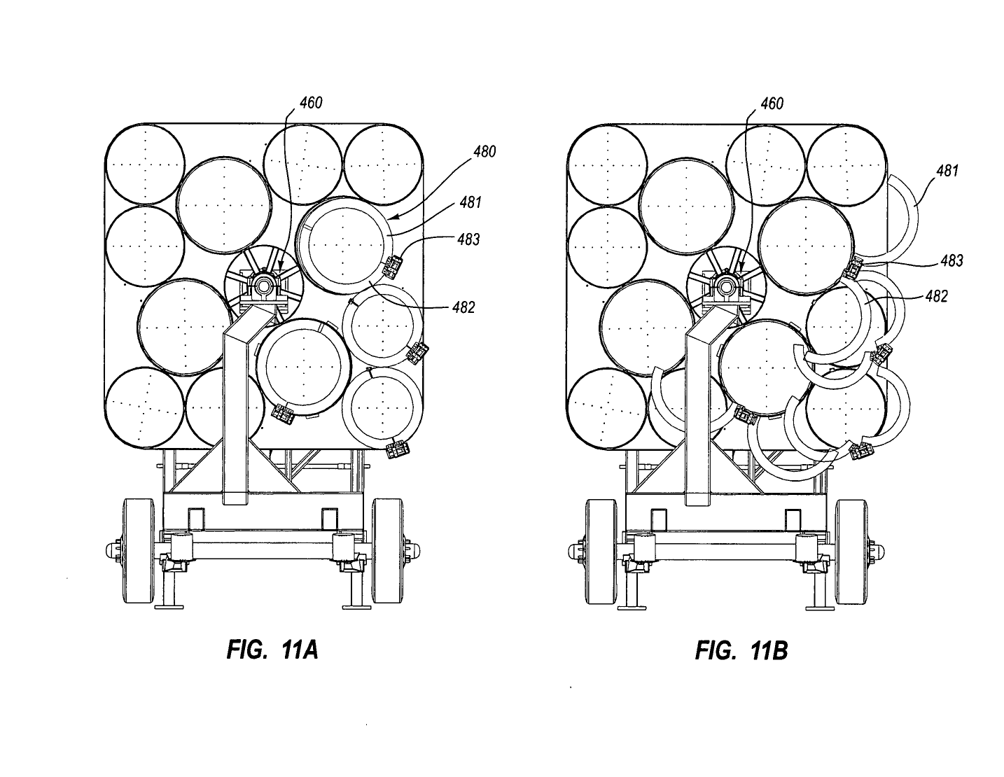

The storage canister triplet in the lower right (from the rear perspective—i.e., the perspective of FIGS. 11A and 11B) quadrant is the load/unload quadrant. In the load/unload quadrant, storage canisters 412 and 413, which are positioned vertically adjacent to one another, are configured to receive traffic barrel drum portions. Storage canister 414 is configured to receive traffic barrel base portions.

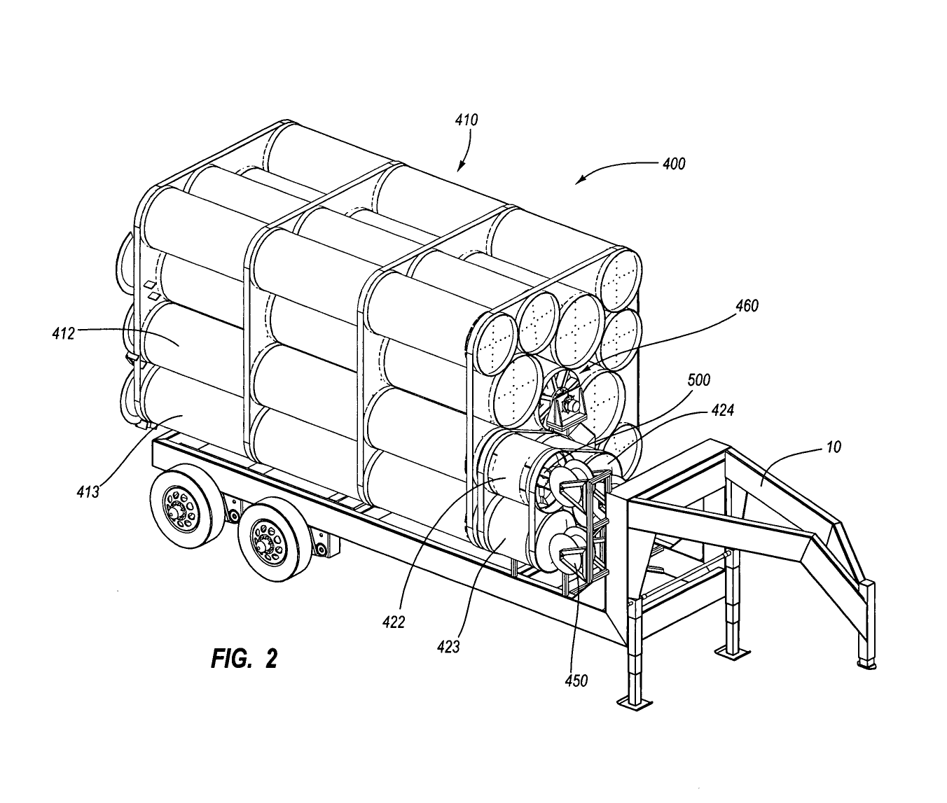

Storage unit 400 also includes a crawler home 420. Crawler home 420 comprises three shorter lengths of storage canister tubing, each of which is aligned and coaxial with one of the storage canisters in the load/unload quadrant. For example, as shown in FIG. 1, crawler home storage canister 422 is coaxial with storage canister 412 in the load/unload quadrant. Likewise, crawler home storage canister 423 is coaxial with storage canister 413 in the load/unload quadrant. The third crawler home storage canister 424 cannot be seen from the perspective of FIG. 1, but is coaxial with storage canister 414 (see FIG. 2). Each of the crawler home storage canisters has an associated crawler, which is configured to push storage barrel drum portions and/or base portions out of a storage canister. The functionality of the crawler units will be described in greater detail later.

FIG. 2 presents a perspective view of storage unit 400 from the front side. A crawler unit 500 is positioned within crawler home storage canister 422. The crawler units in the depicted embodiment are hydraulically operated. Accordingly, they are each connected with a hydraulic hose. The hydraulic hoses may each be wound on a hose reel 450. Each of the respective hose reels may be connected with a power source such that they are configured to automatically turn and wind the hose up, thereby pulling its associated crawler unit back towards the hose reel 450. Thus, when a crawler unit has pushed each of the storage barrel drum portions (or each of the storage barrel base portions) in a given storage canister out, the crawler unit may be pulled back into its home storage canister by automatically winding its associated hose reel.

FIG. 2 also shows a storage canister rotation mechanism 460 which facilitates rotation of the carousel assembly 410. In one embodiment of storage canister rotation mechanism 460, the storage canisters may be support by a shaft suspended between a bearing located at one end of the storage unit 400 and a planetary gear reducer at the other end of the unit. A hydraulic motor may be attached to the planetary gear reducer, thereby providing the necessary torque to turn the carousel assembly 410. When a command is received indicating that the load/unload triplet section is full, or otherwise indicating a need to rotate the carousel, a pin or rod stop extending through the carousel from the storage unit frame may be retracted hydraulically. The hydraulic motor may then be rotated ninety degrees as indicated by a position sensor. Once in position, the stop pin may be extended, thereby securing the carousel from accidental rotational movement during vehicle travel or movement.

A sensor may be placed in one or more of the storage canisters and connected with storage canister rotation mechanism 460 such that, during an unload sequence, upon detecting that a storage canister is empty, storage canister rotation mechanism 460 may be actuated to position a new full triplet of storage canisters in the load/unload quadrant. Likewise, in the load sequence, upon detecting that the storage canister is full, storage canister rotation mechanism 460 may be actuated to position a new empty triplet of storage canisters in the load/unload quadrant.

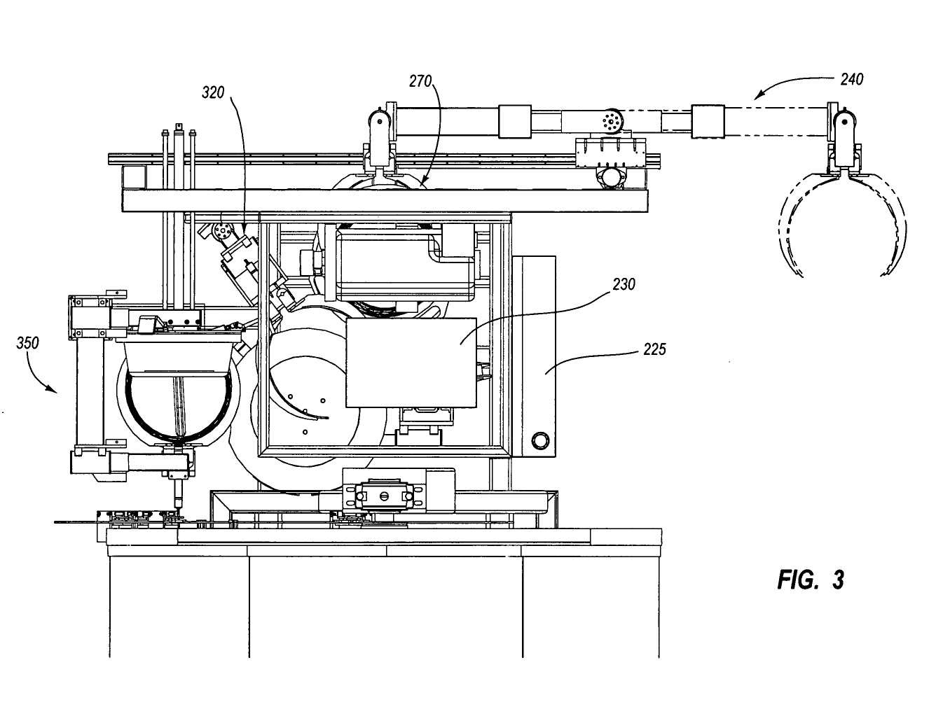

FIG. 3 depicts an overhead view of traffic channelizer handler unit 200. Aspects of traffic channelizer handler unit 200 can be seen in this figure from a different perspective, including fuel tank 225, hydraulic fluid tank 230, pick/place unit 240, base locator plate 270, drum transfer unit 320, and drum actuator unit 350.

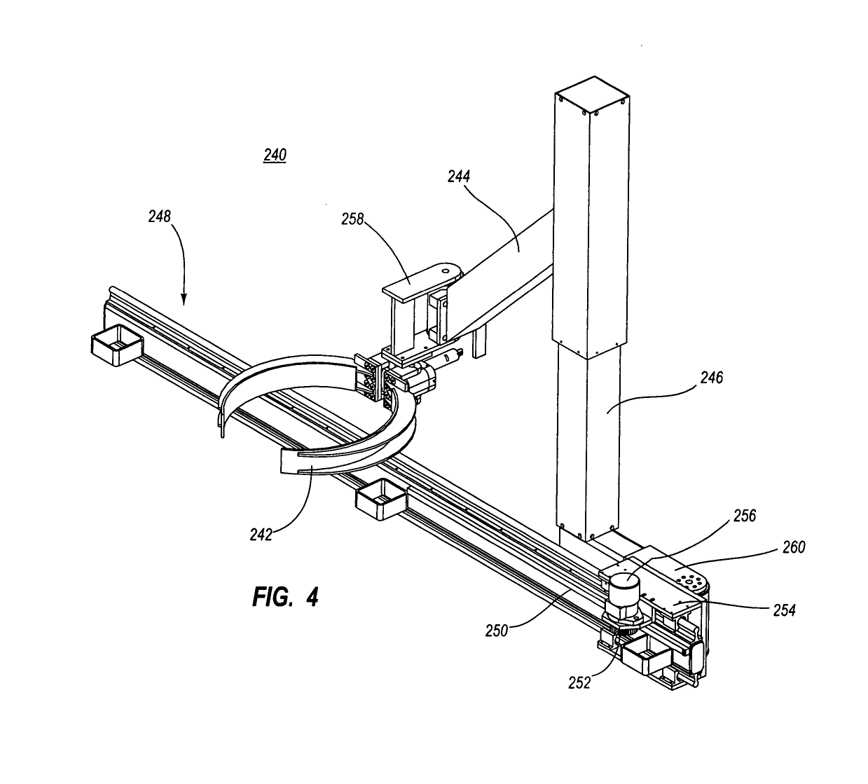

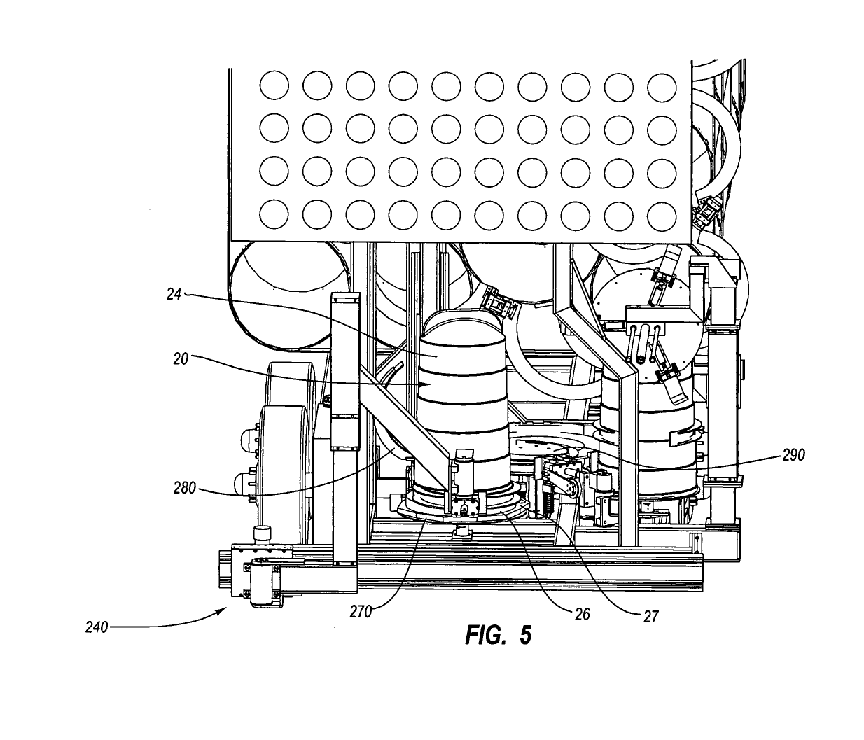

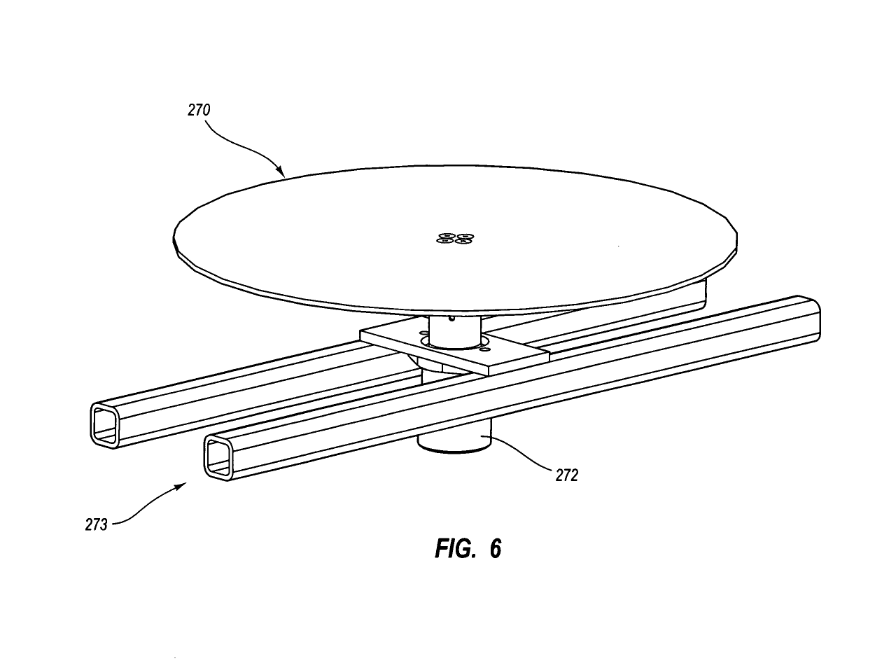

FIG. 4 shows a detailed view of pick/place unit 240. During a “load” sequence, in which the apparatus picks a traffic channelizer up off of a roadway and places it in a storage unit, pick/place unit 240 picks up the traffic channelizer by grabbing it with gripper 242 and places it on base locator plate 270 (see FIGS. 5 and 6). Any number of movements/components may be used to accomplish the steps of grabbing the traffic channelizer and placing it on the base locator plate 270. In the depicted embodiment, a gripper arm 244 is positioned on a hydraulic lift 246. Lift 246 is capable of moving gripper arm 244 up and down as needed to position the gripper 244 around a traffic channelizer. A slide 248 is also provided, which allows lift 246, gripper arm 244, and gripper 242 to slide laterally. In the depicted embodiment, slide 248 includes a drive rack gear 250, a pinion gear 252, and a slide trolley 254. A motor 256 may also be provided to power the movement of the pick/place unit 240. Those of ordinary skill in the art will appreciate that drive rack gear 250 could be replaced with a chain or other linear action device.

Pick/place unit 240 also includes a wrist mechanism 258 that is positioned adjacent to gripper 242, and a slide wrist mechanism 260 that is positioned adjacent to slide trolley 254. Wrist mechanism 258 may be used to adjust the lateral angle with which gripper 242 is positioned with respect to gripper arm 244. Pick/place unit 240 may also include any number of sensors as needed. For example, a sensor may be connected with slide trolley 254 to indicate the linear position of the slide trolley 254 on slide 248. In addition, a sensor may be connected with gripper 242 and configured to sense the presence of a traffic channelizer to be picked up by the apparatus. In some embodiments, the sensor(s) may also provide an indication of the distance between a traffic channelizer and one or more components of the apparatus.

After a traffic barrel or other traffic channelizer has been picked up with pick/place unit 240, it is placed on base locator plate 270, as shown in FIG. 5. FIG. 5 depicts a traffic barrel 20 having a drum portion 24 and a base portion 26. Base portion 26 includes a handle 27. Because for some embodiments it may be desirable to rotationally position the handle 27 of a traffic barrel 20 in a particular way, both for purposes of separating the drum portion 24 from the base portion 26 and for reattaching the drum portion 24 with the base portion 26, a sensor may be provided to locate the position of handle 27. In one embodiment, the base locator plate 270 may be rotated until the sensor detects handle 27 so as to position traffic barrel 20 for the most efficient removal of the drum portion 24 from the base portion 26. In other embodiments, the traffic barrels may be customized for more efficient use thereof in connection with apparatus 100. For example, a small magnet or other detectable feature may be added to the base and/or drum portion of such traffic barrels in order to provide a means for allowing the rotational orientation of the traffic barrels to be detected. A sensor that is capable of detecting a magnetic field may then be provided to detect the magnet and rotationally align the traffic barrels in a desired manner.

A more detailed view of the base locator plate 270 and accompanying components is shown in FIG. 6. As can be seen in this figure, a hydraulic motor 272 is provided, which allows for rotation of plate 270 to facilitate positioning of a traffic barrel for efficient separation of the drum portion from the base portion. In the depicted embodiment, a tubular frame 273 may be used to connect the locator plate 270 to the handler unit frame.

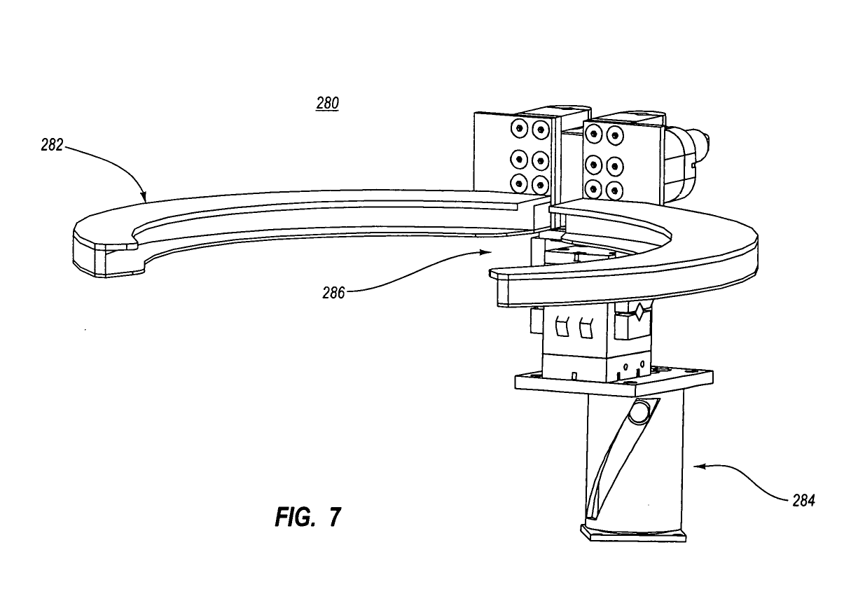

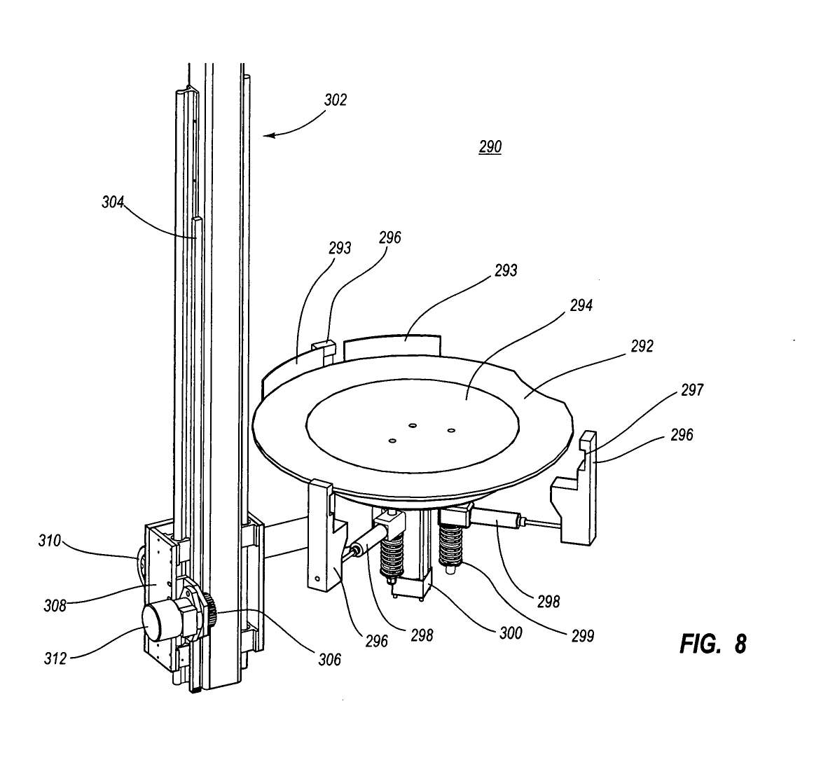

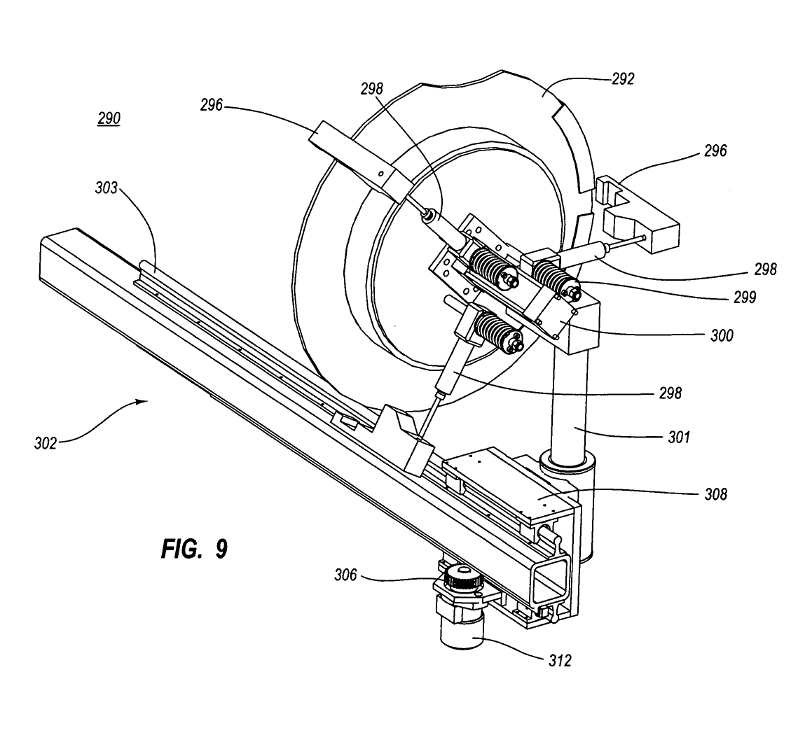

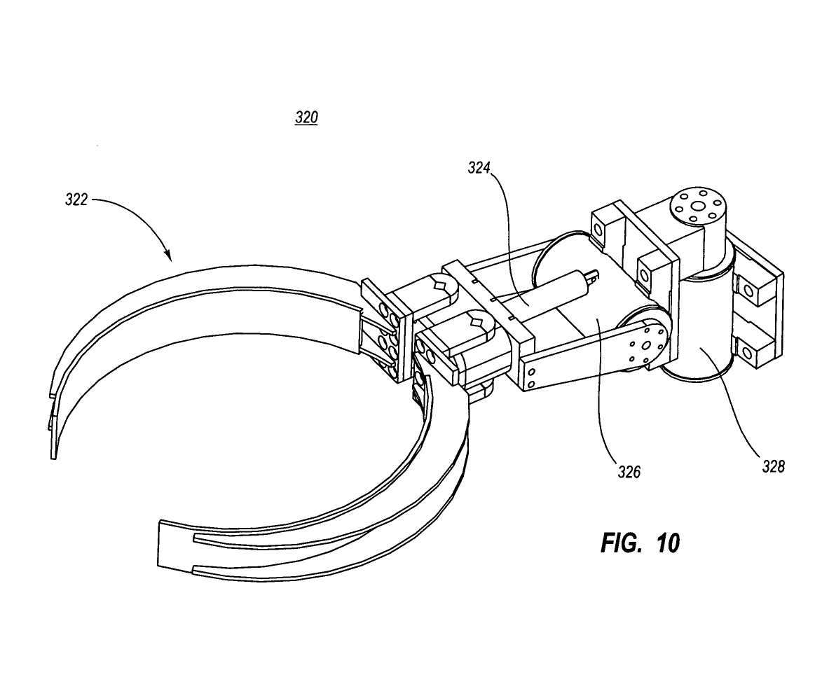

Once the traffic barrel 20 has been rotated into an appropriate position, a base transfer unit 280 and a drum transfer unit 320 (see FIGS. 7 and 10) may be used to separate the base portion of the traffic barrel from the drum portion. Base transfer unit 280 may also be used to transfer the traffic barrel base portion to a base manipulator unit 290, which is shown in detail in FIGS. 8 and 9.

Base transfer unit 280 may comprise any number of mechanisms available to one of ordinary skill in the art. In the depicted embodiment, a gripper 282 is provided, as shown in FIG. 7. The base transfer unit 280 also includes a horizontal/vertical actuator 284 and a vertical wrist rotator 286. Horizontal/vertical actuator 284 allows gripper 282 to rotate laterally while moving up and down, in the depicted embodiment, the movement is accomplished by a helical slot on horizontal/vertical actuator 284 outer housing, as shown in FIG. 7, which may guide the movement of a cam follower bearing device, thereby providing simultaneous rotational and vertical movement during its actuation. The vertical wrist rotator 286 allows gripper 282 to rotate up and down vertically.

Drum transfer unit 320 comprises a drum gripper 322, a gripper cylinder 324, a wrist rotator 326, and a lateral rotator 328, as shown in FIG. 10. Gripper cylinder 324, in combination with wrist rotator 326, allows for drum transfer unit 320 to be rocked back to raise drum gripper 322 back from its horizontal position shown in FIG. 10. Rotator 328 allows drum transfer unit 320 to also rotate laterally.

As described above, base transfer unit 280 is configured to grip the base portion of a traffic barrel and hold it in a fixed position. Likewise, drum transfer unit 320 is configured to grip the drum portion of a traffic barrel. Once base transfer unit 280 and drum transfer unit 320 are both gripping a single traffic barrel, drum transfer unit 320 rocks back, via the wrist rotator 326, to separate the drum portion from the base portion. Upon separating the drum and base portions of the traffic barrel, the drum transfer unit 320 then rotates, via rotator 328, to place the drum portion on a drum locator plate associated with the drum actuator unit 350. Drum actuator unit 350 and its associated functions will be described in greater detail below.

Once the traffic barrel base portion has been transferred to the base manipulator unit 290, base manipulator unit 290 (see FIGS. 8 and 9) may be used to transfer the base portion into a base portion storage canister. In the depicted embodiment, base manipulator unit 290 comprises manipulator plate 292, pusher plate 294, locks 296, lock cylinders 298, base stop 293, pusher springs 299, base pusher 300, support arm 301, vertical slide 302, slide rail 303, rack gear 304, pinion gear 306, base manipulator trolley 308, manipulator rotator 310, and hydraulic motor 312.

As described above, base transfer unit 280 transfers a traffic barrel to base manipulator unit 290. Once the traffic barrel base portion is in this position, a clamp mechanism (not shown) may be used to squeeze the base portion against one or more base stop walls 299, to thereby ensure that the base portion is firmly in place. Then, vertical slide 302 is actuated to raise the base portion to the approximate level of the base portion storage canister in the load/unload quadrant.

At the same time, or subsequent to, the raising of the base portion, rotator 310 is also actuated. Rotator 310 is connected with support arm 301, such that actuation of rotator 310 cause rotation of the entire unit which holds the base portion. The base portion is thereby lifted and rotated to a position in which it is in front of and aligned with a drum portion storage canister in the load/unload quadrant. Once in this position, the base pusher 300 is actuated. Pusher springs 299 allow for the advance of each of the locks 296 until the lips 297 have extended beyond a locking lug or other feature (not shown) extending from the perimeter of the opening of the tube portion of the storage canister. During the advance of the base pusher 300, a stopping surface on the locks 296 contacts the surface of manipulator plate 292, thereby stopping the movement of the locks 296. The pusher springs 299 compress, thereby enabling the base pusher 300 to continue forcing the base forward into the storage canister.

When the lock 296 is stopped in position, an indication to that effect may be provided by a limit switch. Lock cylinders 298 may then be actuated to bring locks 296 in towards the tube storage canister to clamp the lips 297 onto a locking lug or other such feature on the drum storage canister. Once the base is clamped, the base pusher 300 may be actuated to push (by squeezing on the locking lug on the tube storage canister with the manipulator plate 292 via the locks 296). More particularly, actuation of base pusher 300 causes pusher plate 294 to move forward by pulling on the storage canister locking lug, and thereby forcing the base into the storage canister, while simultaneously forcing the bases that are already present in the drum storage canister further into the storage canister.

In some embodiments, a stop mechanism may be connected to each of the storage canisters at the end adjacent to traffic channelizer handler unit 200. The stop mechanism 480 may comprise a pair of separable rims 481 and 482, as shown in FIGS. 11A and 11B. When in a closed position, as shown in FIG. 11A, rims 481 and 482 partially block the opening of a storage canister around its perimeter so as to prevent a traffic barrel drum or base portion from falling out of its associated storage canister. When in an open position, as shown in FIG. 11B, rims 481 and 482 separate and thereby allow for a traffic barrel drum/base portion to be loaded or unloaded from the storage canister. Stop mechanism 480 is configured such that rims 481 and 482 are pivotable about a pivot assembly 483.

The stop mechanism may be configured to automatically open/close at the appropriate times during a load/unload process. For example, the stop mechanism 480 may be configured to open right after a traffic barrel base portion has been lifted and rotated into position in front of a storage canister with base manipulator unit 290 to allow the base portion to be pushed into the storage canister and may be closed after the base portion has been forced into the storage canister with pusher plate 294. Likewise, during an unload process, the stop mechanism may be configured to open as a traffic barrel drum/base portion is forced out of the storage canister, either in whole or in part, and closed thereafter. In the depicted stop mechanism 480, pivot assembly 483 may be configured with a cam actuator lever or rod (not shown). A cylinder or rod on the base manipulator may be used to activate the cam lever rod of the stop mechanism. This may be accomplished automatically, for example, by a rod that actuates the stop mechanism when the manipulator is rotated into place, or by a cylinder that is actuated which, in turn, activates the cam lever of the stop mechanism. The push action of the cam level rod may be used to generate a rotary action to move the stop rims/arms 481 and 482 closed and open. Springs in the stop mechanism may be used to force the rims to a default closed position between actuations. The stop mechanism may therefore be configured to always be in closed configuration unless forced open. Therefore, in the depicted embodiment, the separable rims 481 and 482 can be opened and closed automatically. One process by which the traffic barrel drum/base portions may be forced out of the storage canister during an unload process is described later.

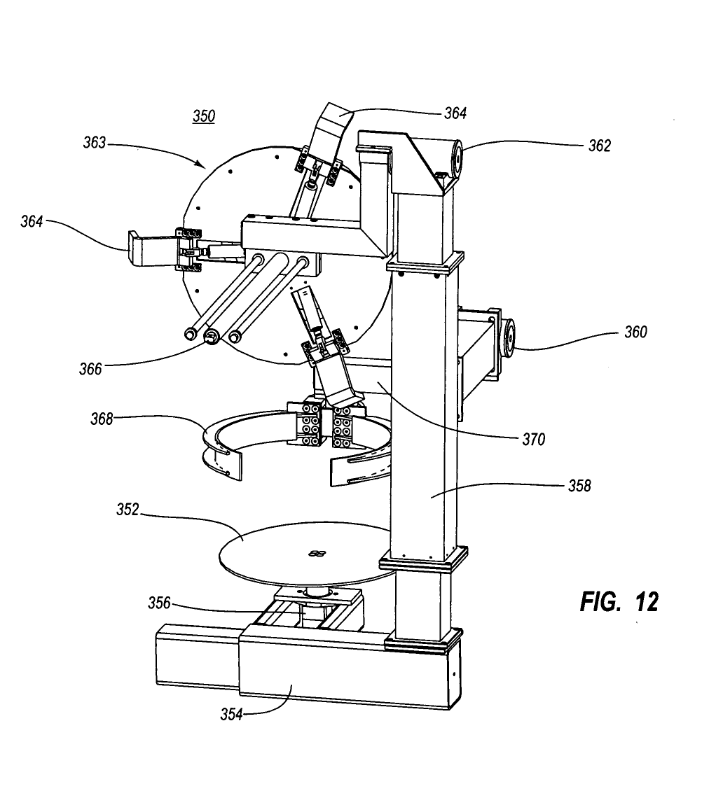

Drum actuator unit 350 is provided to receive a traffic barrel drum portion and force it into a storage canister in the load/unload quadrant. Drum actuator unit 350, as shown in FIG. 12, comprises a drum locator plate 352, a drum actuator transport slide 354, a hydraulic motor 356, a drum lift 358, a drum rotator 360, a drum pusher rotator 362, a drum pusher 363, a plurality of drum clamps 364, a drum pusher cylinder 366, a drum gripper 368, and a drum rotator arm 370. Drum pusher rotator 362 is configured to rotate the drum pusher 363 between horizontal and vertical positions. Likewise, drum rotator 360 is configured to rotate drum gripper 368 between horizontal and vertical positions.

Drum pusher 363 is shown in FIG. 12 in a vertical position. However, drum pusher 363 will typically be in a horizontal position as it awaits receipt of a traffic barrel drum portion. Likewise, drum gripper 368 may be in a vertical position, and/or may be in an open configuration, as it awaits receipt of a traffic barrel drum portion. It should be noted that the drum gripper's horizontal position corresponds with the gripper's holding of a drum in a vertical (or upright) position, and the drum gripper's vertical position corresponds with the gripper's holding of a drum in a horizontal position. In other words, the drum portion sits on the drum locator plate 352 in an upright position and is rotated to a horizontal position, such that it can be pushed into the storage canister, by rotating the drum gripper 368 to a vertical position. Once the drum transfer unit 320 has moved a drum portion from the base locator plate 270 to the drum locator plate 352, drum gripper 368 is rotated and/or closed to secure the drum portion for lifting and/or rotation of the drum portion up to the opening in the drum portion storage canister in the load/unload quadrant.

In preparation for receiving a drum portion, the stop mechanism 480 may be opened. At some point during the process, a sensor may be used to determine whether the drum portion storage canister is full. If so, the storage canister rotation mechanism 460 may be activated to rotate the carousel assembly 410 so as to rotate a new triplet of empty storage canisters into the load/unload quadrant. If the drum portion storage canister is not full, the drum lift 358, which comprises two telescoping rectangular members, may be actuated to raise the drum portion to the height of the drum portion storage canister. In addition, drum rotator 360 may be actuated to rotate the drum portion from an upright position to a horizontal position such that it can be pushed into the drum portion storage canister. After actuating drum rotator 360, the drum pusher may be rotated down and a cone (not shown) or other drum alignment member, which may be positioned on the end of the drum pusher 363, may be used to hold the drum in place.

Once the drum is in position to be forced into the drum portion storage canister, the drum pusher 363 may be actuated forward until the drum is completely inside the storage canister, which may occur just prior to the drum pusher contacting the rim of the storage canister. The drum actuator may then be used to retract the drum pusher 363. The drum rotator may then be rotated down at a position where it is ready to receive a new drum. The drum pusher 363 in the retracted position may then be activated up to its home position to awaits the next operation. The drum clamps 364 may remain in their unclamped or open position during a load into the tube such that the pusher can move all the way to the face of the storage canister without the clamps interfering with the storage canister.

In the drum removal process, the drum clamps on the drum pusher may be used to extract the drum from the tube. During this process, the drum rotator 362 may be moved up with its clamp open. The base pusher 363 may be moved down and extended to, for example, about three inches away from the rim of the storage canister. The crawler may then be activated, which moves the base out of the storage canister to contact the drum pusher alignment member (not shown), which may be used pilots the drum into position on the drum pusher 363. When the drum is in position on the alignment member and seated with the face/plate of the drum pusher, as may be indicated by a limit switch or sensor, the stop mechanisms may be closed.

The clamps may then be activated, which clamp on to the rim of the drum. The drum pusher may then be retracted to thereby force the drum out of the storage canister. The stop mechanism on the storage canister prevents the adjacent drum (the drum “on deck”) from being moved or extracted accidentally. With the drum pusher 363 fully retracted, the gripper 368 may then clamp the drum. The drum pusher clamps 364 may then be released, after which the drum pusher 363 may be rotated up out of the way. The drum rotator 360 may then be rotated down and the drum placed on the drum locator 352 of the drum actuator unit 350. The gripper 368 may then be opened, after which the drum locator 352 may rotate the drum into position, as may be indicated by a switch or sensor.

Following the insertion of the drum portion in the storage canister, the drum pusher 363 may be retracted and the stop mechanism 480 may be closed to hold the drums within the storage canister. In addition, the drum pusher 363 and/or the drum gripper 368 may be moved/rotated to their respective home positions to await the next drum portion.

The process for unloading a traffic barrel or other traffic channelizer will now be described in detail. It should be understood that several of the steps involved in unloading traffic barrels may be accomplished simply by reversal of the steps described above for loading traffic barrels. However, where significant differences exist between the load process and the unload process, those differences will be explained below.

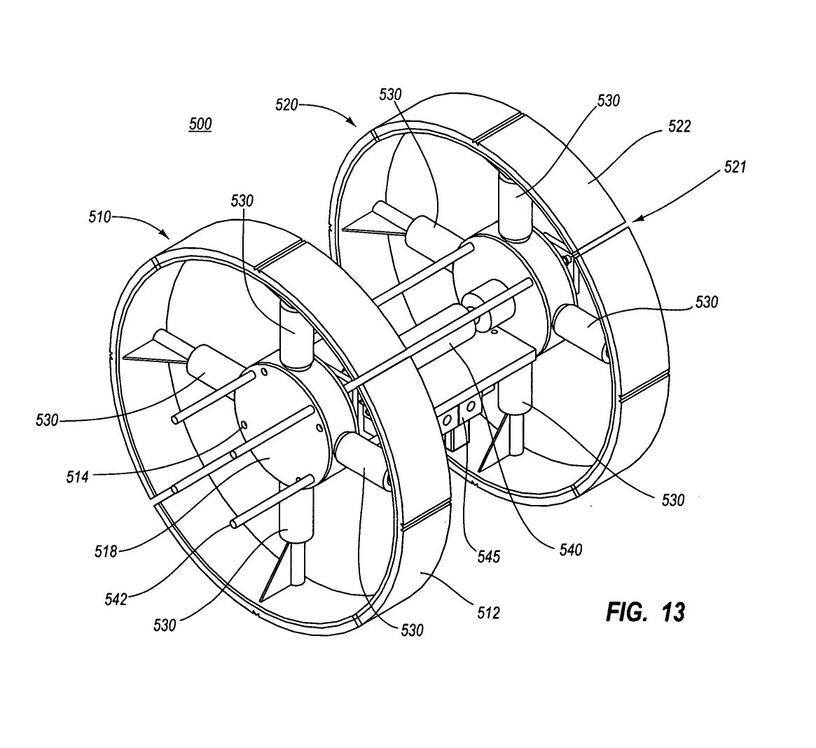

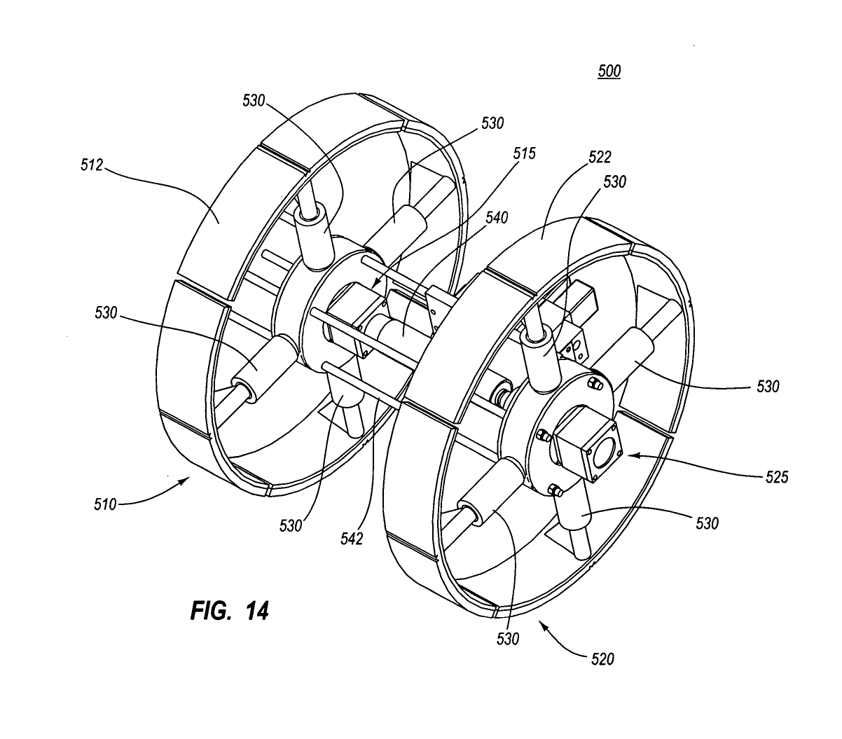

As mentioned earlier, each of the storage tubes has an accompanying crawler 500. As shown in FIGS. 13 and 14, crawler 500 comprises a first brake ring 510 and a second brake ring 520. Each of the respective brake rings have a brake surface, 512 and 522, respectively. Brake surfaces 512 and 522 are configured to be expanded radially to a brake “set” position and to be retracted to a brake “released” position. With crawler 500 positioned within a storage canister or other tubular structure, expanding brake ring 510 to a “set” position will cause brake surface 512 to engage the interior surface of the storage canister, thereby locking brake ring 510 in place. Likewise, expanding brake ring 520 to a “set” position will cause brake surface 522 to engage the interior surface of the storage canister, thereby locking brake ring 520 in place.

Brake actuators 515 and 525 (best seen in FIG. 14) are configured to actuate brake rings 510 and 520, respectively, by causing brake extension rods/guides 530 to force brake surfaces 512 and 522 radially outward. One or more brake surface gaps 521 (see FIG. 13) may be formed in each of the brake surfaces to allow for separation of segments of the brake surfaces during an expansion process. Of course, brake actuators 515 and 525 may be capable of being individually actuated. Thus, brake actuator 515 may actuate/set brake ring 510 to engage brake surface 512 with an interior wall of a storage canister while brake ring 520 is in a released position with brake surface 522 set back from the interior wall of the storage canister to allow brake ring 520 to move towards (or away from) brake ring 510.

One or more features within a central housing 518 in each of the brake rings may facilitate the actuation of the brake rings between “set” and “released” positions. In the depicted embodiment, a brake actuator piston rod (not shown) may be attached to the central housing 518 within brake actuators 515 and 525. The brake actuators 515 and 525 each have a housing that has four tapers, thereby forming a blunt pyramid shape on the front of the housing unit. The tapers on the brake actuator may contact corresponding mating tapered surfaces on the rods, which are part of brake extension guides/rods 530. These rods are guided by the brake extension guides and, as the brake actuators 515/525 activate the pistons inside the brake actuators, these pistons extend and retract, which may be hydraulically powered. When the actuators 515/525 retract, they pull the two tapered surfaces together, thereby expanding the brake surfaces 512 and 522. When the actuators 515/525 retract, they pull the tapered surfaces apart, thereby retracting or releasing the brake surfaces 512/522.

A plurality of guide rods 542 extend between brake ring 510 and brake ring 520. Guide rods 542 are affixed to brake ring 520 and are slidably received within openings 514 in central housing 518 of brake ring 510. Thus, within a fixed range of motion, brake ring 510 may be approximated with and/or moved apart from brake ring 520. Relative movement between the two brake rings is facilitated by an extend/retract cylinder 540 or, more generally, an extendable member 540, positioned between and connecting brake ring 510 with brake ring 520. Extend/retract cylinder 540 provides the force by which the brake rings may be separated from and/or approximated with one another. An extend actuation command causes cylinder 540 to force the two brake rings apart. Similarly, a retract actuation command causes cylinder 540 to approximate or bring the two brake rings together.

Crawler 500 may be hydraulically powered. Thus, a hydraulic hose may be connected with the crawler at a port (not shown). A hydraulic manifold 545 with one or more solenoid valves may therefore be provided to control the operation of various components, including the extend/retract cylinder 540 and the brake extension rods/guides 530. Each of the hydraulic hoses may be wound onto an automated hose reel 450, as shown in and previously described with reference to FIGS. 1 and 2.

As previously mentioned, crawlers 500 are provided to force traffic barrel drum and/or base portions out of their associated storage canisters. In some embodiments, one or more friction-fit plugs (not shown) may be provided between the crawlers and the traffic barrel components that they are configured to move. Such a plug may be provided to prevent the traffic barrel drum/base portions from falling out of the front of a storage canister. In addition, when used in connection with traffic barrel base portions, the plug may prevent the bases from tipping over within the storage canister. One or more sensors may also be provided, some of which may be positioned on the plugs and/or may operate in conjunction with the plugs, such that it can be determined when a storage canister is full (the plug is pushed all the way to a sensor at the front of the storage canister), or when a storage canister is empty (the plug is pushed all the way to a sensor at the rear of the storage canister).

When an initial indication is received that a drum or base portion is to be pushed out of its storage canister to be placed on a roadway, each of the crawlers 500 is in its respective crawler home storage canister within crawler home 420. Upon receiving such an indication, the appropriate crawler 500 begins moving out of its crawler home and into the storage canister adjacent to and aligned axially with its crawler home storage canister.

To move down the storage canister, the crawler first engages the brake ring that is closest to hose reel 450, which, in the depicted embodiment, is brake ring 510. As brake surface 512 is engaged with the interior surface of the tube, cylinder 540 is actuated to force brake ring 520 away from brake ring 510. Then, brake ring 510 is disengaged from the interior surface and brake ring 520 is engaged. Cylinder 540 is then actuated in the opposite direction to draw brake ring 510 towards brake ring 520. This process is repeated until the traffic barrel drum portion or base portion has been pushed a sufficient distance to be accessed by base manipulator unit 290 or drum actuator unit 350. Once the crawler 500 has pushed each of the traffic barrel drum or base portions in a given storage canister out, it may be pulled back to its crawler home storage canister by actuating the hose reel 450. Of course, both of the brake rings are disengaged prior to winding hose reel 450 to pull the crawler out of an empty storage canister.

To retrieve a traffic barrel base portion from its storage canister, base manipulator unit 290 is actuated to cause plate 292 to move up slide 302 and adjacent to the storage canister. Plate 292 is then rotated such that it is aligned to receive the base portion from the storage canister. The base portion is then pushed out of the storage canister with crawler 500. The stop mechanism 480 is, of course, opened prior to pushing the base portion out. The base portion is then clamped onto plate 292 and the stop mechanism 480 is closed. Plate 292 is then rotated and slide 302 lowers the base portion back to its home position.

As the base portion is retrieved from its storage canister, the traffic barrel's drum portion may simultaneously be retrieved from its storage canister. To do so, drum gripper 368 may be moved to its open position in preparation for receiving the drum portion when rotated up to the storage canister. Drum lift 358 and drum pusher rotator 362 may then be actuated to lift and/or rotate the drum pusher 363 to a position adjacent to and aligned with the traffic barrel drum portion storage canister.

The apparatus may be configured such that the drum portion storage canister stop mechanism is opened, after which the crawler pushes the nested stack of drums until an engageable feature (such as a drum lip, as are common on many traffic barrels) on a single drum is pushed just past the stop mechanism. The stop mechanism may then be closed such that one or more features of the stop mechanism is positioned between the drum that is to be removed and the adjacent drum (the drum “on deck”). In this manner, a single drum may be pulled from the nested stack of drums within the storage canister without pulling additional drums that may be stuck together with the single drum. One or more sensors may be provided to sense when a traffic barrel is in the appropriate position so that the crawler 500, and other components of the apparatus, can receive an appropriate indication as to when to engage and/or disengage.

After the stop mechanism 480 has been closed, drum clamps 364 may then be actuated to engage a drum lip or other feature of a single drum. Drum pusher 363 then retracts, thereby extracting the drum from the storage canister. As described above, because the stop mechanism 480 is closed between the target drum and its adjacent drum, the target drum may be extracted without also retracting adjacent drums. Thereafter, drum gripper 368 is closed around the drum to support the drum in preparation for moving it down to the drum locator plate 352. Once the drum is in this position, the drum clamps 364 are opened and the drum pusher 363 is rotated up to its home position, after which the drum is rotated down to the drum locator plate 352. Gripper 368 then releases the drum for the drum transfer unit 320. Finally, drum locator plate 352 rotates such that the drum is in a rotational orientation that may be desirable in reattaching the drum with a base. One or more sensors may be used to identify when the drum is in an appropriate rotational orientation and therefore rotation of drum locator plate 352 should stop, as previously described in connection with base locator 270.

Prior to the drum being moved to locator plate 270 (which is essentially the reverse of the steps for transferal of the drum from the locator plate to the drum actuator 350), the base portion is first moved to locator plate 270. This step is accomplished with base transfer unit 280. Gripper 282 of base transfer unit 280 grabs the base portion and moves it to locator plate 270 by actuation of horizontal rotator 284 and/or vertical rotator 286. Gripper 282 may then rotate back out of the way.

Once the base portion has been moved to locator plate 270, locator plate 270 rotates until it is in an appropriate rotational orientations for attachment of a drum thereto. The drum may then be grabbed with gripper 322 of drum transfer unit 320 and moved to the base, which is already positioned on locator plate 270. Wrist rotator 326 may then be actuated to place the drum on the base. The gripper 322 can then be opened and rotated to its home position via wrist mechanisms 326 and/or 328.

Once the traffic barrel has been put together and is positioned on locator plate 270, it is in position to be received by pick/place unit 240. To do so, gripper 242 is moved into position and closed to clamp onto the traffic barrel. Similar to the load process, this is accomplished by moving slide trolley 254 along the horizontal slide 248 to the unload position. This position may be on the right or left side of the vehicle, depending upon the operator's selection as to the desired traffic barrel placement. Wrist 258 may rotate simultaneously with the movement of gripper arm 244 to position gripper 242 in the appropriate position. Lift 246 may also move simultaneously with the wrist and/or arm movements.

The command to place/drop the traffic barrel may be activated by the logic which calculates the distance traveled in the vehicle since the previous drop and a setpoint value the operator can input as to the desired distance spacing between traffic barrels. Gripper 242 may be opened once the traffic barrel is in a drop position and the traffic barrel is placed on to the roadway. The gripper 242 may then be moved back to a position at which it can grab another traffic barrel.

Those of ordinary skill in the art will appreciate that numerous variations to the embodiments, components, steps, etc., disclosed above, are possible. In addition, some embodiments of the invention may include a means for controlling the operation of the apparatus. Such a control means may include a means for allowing a user to configure the distance between adjacent traffic channelizers placed onto the roadway by the apparatus such that the apparatus places traffic channelizers on the roadway substantially at a preselected distance apart. The operation of one or more components of the apparatus may also be linked with the speed of the trailer such that the preselected distance between traffic channelizers is maintained for a given trailer speed up to a threshold trailer speed. The control means may also notify a user when the speed of a vehicle associated with the apparatus has exceeded a threshold speed for maintaining a predetermined distance between adjacent traffic channelizers placed onto the roadway by the apparatus. The control means may also allow for a user to enter the predetermined distance in a keyboard, touch screen, or other input means. In addition, the device may include a speed sensor that senses how fast the vehicle pulling the trailer is traveling, and may automatically adjust the drop speed of the apparatus in response thereto.

Some embodiments may also include a tapering feature. Such a tapering feature may provide for automated placement of traffic channelizers on a roadway at a distance from the apparatus that varies incrementally so as to result in a tapered placement of traffic channelizers along the roadway. The tapering feature may allow for selection of tapering in either direction across the width of a roadway.

The above description fully discloses the invention including preferred embodiments thereof. Without further elaboration, it is believed that one skilled in the art can use the preceding description to utilize the invention to its fullest extent. Therefore the examples and embodiments disclosed herein are to be construed as merely illustrative and not a limitation of the scope of the present invention in any way.

It will be apparent to those having skill in the art that many changes may be made to the details of the above-described embodiments without departing from the underlying principles of the invention. The scope of the present invention should, therefore, be determined only by the following claims.

1. An apparatus for the automated placement and removal of traffic channelizers, comprising:
a traffic channelizer handler unit for removing a traffic channelizer from a roadway and for subsequent placement of the traffic channelizer on the roadway; and
a storage unit for receiving the traffic channelizer, wherein the traffic channelizer handler unit is configured to place the traffic channelizer in the storage unit and retrieve the traffic channelizer from the storage unit.

2. The apparatus of claim 1, wherein the storage unit comprises a storage canister configured to receive a plurality of traffic channelizers in a nested configuration.

3. The apparatus of claim 2, wherein the storage unit comprises a plurality of storage canisters, each of which is configured to receive a plurality of traffic channelizers in a nested configuration.

4. The apparatus of claim 2, wherein the storage unit further comprises a crawler that is configured to selectively affix to an interior surface of the storage canister and move axially along the storage canister to move traffic channelizers out of an opening in the storage canister.

5. The apparatus of claim 4, wherein the crawler comprises:
a first brake ring configured to actuate a first brake surface;
a second brake ring configured to actuate a second brake surface; and
an extendable member connected between the first brake ring and the second brake ring, wherein the crawler is configured to move axially along the storage canister by actuating the first brake ring to press the first brake surface against the interior surface, actuating the extendable member to separate the first brake ring from the second brake ring, actuating the second brake ring to press the second brake surface against the interior surface, and actuating the extendable member to approximate the first brake ring with the second brake ring.

6. The apparatus of claim 4, wherein the crawler is hydraulically powered.

7. The apparatus of claim 4, wherein the storage unit comprises a plurality of storage canisters, each of which is configured to receive a plurality of traffic channelizers in a nested configuration, and wherein the apparatus comprises a plurality of crawlers, each of which is configured to selectively affix to an interior surface of a separate storage canister and move axially along the storage canister.

8. The apparatus of claim 2, wherein the storage unit further comprises a sensor for determining the presence of a traffic channelizer in the storage canister.

9. The apparatus of claim 8, wherein the sensor is configured for determining the number of traffic channelizers in the storage canister.

10. The apparatus of claim 1, wherein the traffic channelizer comprises a traffic barrel including a drum portion and a base portion, wherein the drum portion is separable from the base portion.

11. The apparatus of claim 10, wherein the storage unit comprises a storage canister for storage of the traffic barrel drum portions and a separate storage canister for storage of the traffic barrel base portions.

12. The apparatus of claim 11, further comprising a drum actuator configured to separate traffic barrel base portions from traffic barrel drum portions.

13. The apparatus of claim 12, further comprising a base actuator configured to move traffic barrel base portions into the base portion storage canister.

14. The apparatus of claim 1, wherein the traffic channelizer handler unit is detachable from the storage unit.

15. The apparatus of claim 1, wherein the traffic channelizer handler unit comprises a gripping arm configured to grip traffic channelizers and remove the traffic channelizers from the roadway, and wherein the gripping arm is further configured to release the traffic channelizers to place the traffic channelizers back on the roadway.

16. The apparatus of claim 1, further comprising a trailer connected with the traffic channelizer handler unit and the storage unit, wherein the apparatus is configured to place traffic channelizers on the roadway such that the traffic channelizers are substantially at a predetermined distance apart, and wherein the operation of one or more components of the apparatus are linked with the speed of the trailer such that the preselected distance between traffic channelizers is maintained for a given trailer speed up to a threshold trailer speed.

17. The apparatus of claim 16, wherein the apparatus is configured to allow for user selection of the predetermined distance.

18. The apparatus of claim 17, wherein the apparatus is configured to allow for user selection of a tapering feature, wherein the tapering feature provides for automated placement of traffic channelizers on a roadway at a distance from the apparatus that varies incrementally so as to result in a tapered placement of traffic channelizers along the roadway.

19. An apparatus for the automated placement and removal of traffic channelizers, comprising:
means for moving a plurality of traffic channelizers from a roadway and onto a vehicle;
means for moving the traffic channelizers into a storage area connected with the vehicle;
means for removing the traffic channelizers from the storage area; and
means for placing the traffic channelizers onto the roadway.

20. The apparatus of claim 19, wherein the vehicle comprises a trailer.

21. The apparatus of claim 19, wherein the vehicle is self-contained and drivable with each of the necessary components to provide for the automated placement and removal of traffic channelizers.

22. The apparatus of claim 19, wherein the means for moving a plurality of traffic channelizers from a roadway and onto a vehicle comprises the means for moving the traffic channelizers into a storage area connected with the vehicle.

23. The apparatus of claim 19, wherein the storage area comprises a storage canister configured to receive a plurality of traffic barrels in a nested configuration.

24. The apparatus of claim 23, further comprising means for pushing the traffic barrels out of the storage canister.

25. The apparatus of claim 23, further comprising a trailer, wherein the storage canister is connected with the trailer.

26. The apparatus of claim 19, wherein the apparatus is configured to be removably connected with a vehicle.

27. The apparatus of claim 19, further comprising means for detecting the presence of traffic channelizers.

28. The apparatus of claim 27, wherein the means for detecting the presence of traffic channelizers comprises means for detecting when no traffic channelizers remain within at least one component of the storage area.

29. The apparatus of claim 19, wherein the traffic channelizers each comprise a traffic barrel including a drum portion and a base portion, wherein the drum portion is separable from the base portion.

30. The apparatus of claim 29, further comprising means for separating the drum portions of the traffic barrels from the base portions.

31. The apparatus of claim 30, further comprising means for moving the base portions into a storage canister in the storage area.

32. The apparatus of claim 19, further comprising means for controlling the operation of the apparatus.

33. The apparatus of claim 32, wherein the control means comprises means for allowing a user to configure the distance between adjacent traffic channelizers placed onto the roadway by the apparatus.

34. The apparatus of claim 32, wherein the control means comprises means for notifying a user when the speed of a vehicle associated with the apparatus has exceeded a threshold speed for maintaining a predetermined distance between adjacent traffic channelizers placed onto the roadway by the apparatus.

35. An apparatus for the automated placement and removal of traffic barrels, comprising:
a traffic barrel handler unit for removing traffic barrels from a roadway and for subsequent placement of the traffic barrels on the roadway; and
a storage unit operatively connected to the traffic barrel handler unit for receiving the traffic barrels, wherein the traffic barrel handler unit is configured to place the traffic barrels in the storage unit and retrieve the traffic barrels from the storage unit for placement of the traffic barrels on the roadway by the traffic barrel handler unit, and wherein the storage unit comprises a plurality of traffic barrel canisters, each of which is configured to receive a plurality of traffic barrels in a nested configuration;
a crawler that is configured to selectively affix to an interior surface of one of the storage canisters and move axially along the storage canister to push traffic barrels out of an opening in the storage canister.

36. The apparatus of claim 35, wherein the traffic barrels comprise a drum portion and a base portion, wherein the drum portion is separable from the base portion.

37. The apparatus of claim 36, further comprising at least one storage canister configured to receive a plurality of traffic barrel base portions, wherein the apparatus is configured to separate the drum portion of a traffic barrel from the base portion of a traffic barrel, place the base portion within a first storage canister, and place the base portion within a second storage canister.
